(19) United States
(12) Patent Application Publication
(10) Pub. No.: US 2016/0173895 A1
(43) Pub. Date: Jun. 16, 2016

(54) METHOD AND DEVICE FOR STORING AND READING DATA, PARTICULARLY VIDEO DATA, IN STORAGE BLOCKS

(71) Applicant: STMICROELECTRONICS (GRENOBLE 2) SAS, Grenoble (FR)

(72) Inventor: Gilles RIES, Saint-Jean de Moirans (FR)

(21) Appl. No.: 14/855,573

(22) Filed: Sep. 16, 2015

(30) Foreign Application Priority Data
Dec. 12, 2014 (FR) 1462348

(51) Int. Cl. H04N 19/423; H04N 19/119; H04N 19/169; H04N 19/46

(52) U.S. Cl. CPC H04N 19/423; H04N 19/46; H04N 19/119; H04N 19/169

(57) ABSTRACT

A method for storing data in storage blocks having a constant storage size may include grouping the data into successive data groups, and compressing each data group into a compressed block having a block size smaller than or equal to the storage size. The method may further include, for at least one compressed block having a block size smaller than the storage size, inserting into the at least one compressed block, before storage in a storage block, at least one information element relating to the contents of at least one further compressed block.

### TECHNICAL FIELD

Applications and embodiments of the invention relate to the processing of data, such as video data, and more particularly to the compression of data for storage in storage blocks of a memory device.

### BACKGROUND

In order to reduce bandwidth, i.e., the amount of data to be written to or read from a memory, as well as the size of this memory, the data (e.g., video data such as pixels) is generally subjected to a compression process before storage. As a general rule, two types of compression may be used. A first form of compression is compression with losses (for which the English term “lossy compression” is commonly used by those skilled in the art), while a second possible type of compression is compression without losses (for which the English term “lossless compression” is commonly used by those skilled in the art).

In lossy compression, the compression rate is fixed, e.g., at a compression rate of 2×. This provides a reduction of bandwidth and a reduction of the size-of the storage blocks by a factor of 2. However, because of the loss of information, a compromise between compression and image quality may be desired.

Lossless compression uses a compression rate which may be variable, typically varying from 1.1× to 16×. This provides desired image quality, because the compression is lossless. On the other hand, this type of compression requires the use of a buffer memory stage (commonly referred to by those skilled in the art as a “header buffer”) for storing the information that enables the compressed data to be retrieved from the memory. This results in an increase in the surface area and double accessing, namely the accessing of the header buffer followed by the accessing of the memory itself. However, the reduction in bandwidth may be greater than in the case of lossy compression.

### SUMMARY

According to one application and embodiment, an approach is provided for storing compressed data in storage blocks in which the resulting reduction in bandwidth is comparable to that which could be obtained by lossless compression, with an assured outcome comparable to that obtained by lossy compression, while avoiding double memory access of the type used in lossless compression.

According to one aspect, a method is provided for storing data in storage blocks having a constant storage size. The method may include grouping the data into successive data groups, and compressing each data group into a compressed block having a block size smaller than or equal to the storage size. The method may further include, for at least one compressed block having a block size smaller than the storage size, inserting into the at least one compressed block, before storage in a storage block, at least one information element relating to the contents of at least one subsequent compressed block.

Thus, if the content of a data group is suitable for this purpose, resulting in a compressed block and a block size smaller than the storage size of the storage blocks, the remaining free space in this compressed block may then be used for the insertion of at least one information element relating to the content of at least one subsequent compressed block. This will enable this information element to be taken into account for the reading of the subsequent compressed block or blocks. This may avoid, for example, having to read the block or blocks in their entirety even though this is not necessary or useful in all cases. In other words, because this information element is taken into account, it is only the compressed content of a subsequent block, for example, that will be read together with one or more other information elements within the free space of the same subsequent block relating to the contents of other subsequent blocks, if necessary.

Thus, according to this aspect, an indication is placed in some way within the compressed block, relating to the subsequent compressed block. This indication may be located in the header buffer in the case of lossless compression. Consequently, the header buffer and any double accessing of the memory may be avoided in this case.

A plurality of information elements relating to the contents of a plurality of respective subsequent blocks may be inserted into the at least one compressed block. Furthermore, according to one embodiment, the method may further include inserting into each current compressed block of a sequence of a plurality of successive compressed blocks a plurality of information elements, each relating to a respective sub-sequence of a plurality of successive subsequent compressed blocks. The first compressed block of the sub-sequence may be the first compressed block following the current compressed block.

Although successive storage blocks are read in the subsequent memory reading step, these blocks are not necessarily consecutive, and these storage blocks may be be accessed in a random manner. Thus, providing a redundancy of information elements in a plurality of compressed blocks of a sequence of blocks enables losses of this information element to be avoided in random access.

The information element may be an information element relating to the compression rate of the subsequent block, e.g., the number of groups of octets (bytes) to be read in the subsequent compressed block, or an information element relating to the possibly transparent nature or characteristic of the content of the subsequent block. This will enable its reading to be avoided in the reading step.

According to another aspect, a method is provided for reading data in successive storage blocks having a constant storage size, with each storage block including a block of compressed data (e.g., values of pixels). The method may include reading the contents of the current compressed data block. If at least one information element relating to the contents of at least one subsequent compressed block is present in the current block, the at least one information element for the subsequent reading of the at least one subsequent compressed block is taken into account.

According to another aspect, a processing device is provided which may include an input interface for receiving data to be stored in storage blocks having a constant storage size. A processor or processing means may be configured to group the data into successive data groups, to compress each data group into a compressed block having a block size smaller than or equal to the storage size, and, for at least one compressed block having a block size smaller than said storage size, to insert into the at least one compressed block at least one information element relating to the contents of at least one subsequent compressed block. An output interface may be configured to deliver the successive compressed blocks to a memory including storage blocks.

According to one embodiment, the processor is also configured to insert into the at least one compressed block a plurality of information elements relating, respectively, to the contents of a plurality of subsequent compressed blocks. According to another embodiment, the processor may also be configured to insert into each current compressed block of a sequence of a plurality of successive compressed blocks a plurality of information elements, relating, respectively, to a sub-sequence of a plurality of successive subsequent compressed blocks. The first compressed block of the sub-sequence may be the first compressed block following the current compressed block.

According to another aspect, a processing device is provided which may include an input interface coupled to a memory including successive storage blocks having a constant storage size. Each storage block may include a block of compressed data, and reading means or circuitry configured to read the content of the current compressed data block and, if at least one information element relating to the content of at least one subsequent compressed block is present in the current block, taking into account the at least one information element for the subsequent reading of the at least one subsequent compressed block.

### BRIEF DESCRIPTION OF THE DRAWINGS

Other advantages and features will be become apparent in the detailed description of applications and embodiments, which are in no way limiting, and the appended drawings, in which:

FIG. 1 is a flow diagram illustrating a method in accordance with an example embodiment;

FIG. 2 is a schematic diagram of memory storage blocks which may be used in accordance with an example embodiment;

FIG. 3 is a flow diagram illustrating an example memory reading method in accordance with an example embodiment;

FIG. 4 is a schematic block diagram of a processing device which may be used to implement memory storage operations in accordance with an example embodiment; and

FIG. 5 is a schematic block diagram of a memory access device which may be used in accordance with an example embodiment.

### DETAILED DESCRIPTION

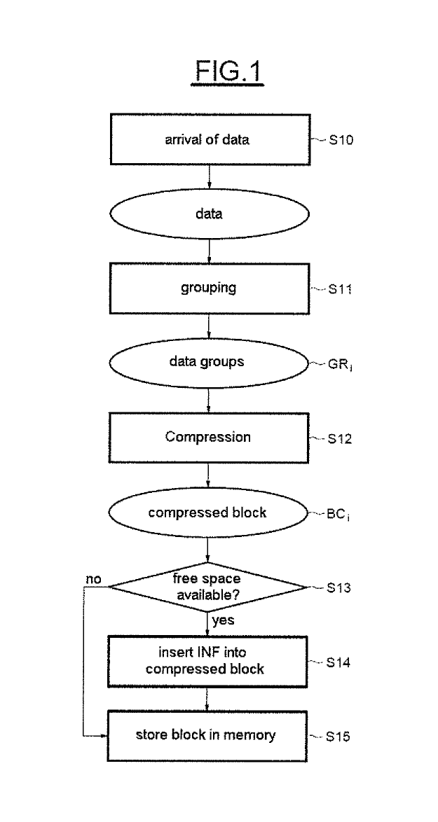

A flow diagram of an embodiment of a data storage method according to an example aspect is shown in FIG. 1. In step S10, the data, for example video data (pixels) conforming to the MPEG standard, arrive and are grouped in step S11 to form successive data groups GRᵢ. The groups GR, undergo compression (step S12). Depending on the contents of the data group, this compression may be a compression of the lossy type, having a compression rate of 2× for example, or a lossless compression, having a higher compression rate. Thus, a compressed block BCᵢ is obtained for each data group GRᵢ.

If, for a compressed block BCᵢ, there is free space available at the end of the compression (because the size of the compressed block is smaller than the storage size of the storage block in which the compressed block is to be stored), it is advantageously possible to include at least one information element INF (step S14) relating to the content of a subsequent compressed block in this free space. The insertion of this information element INF takes place after the compression of the subsequent compressed block, because the content of this subsequent compressed block should be known before the corresponding information element INF is inserted in the previous compressed block.

The compressed block, including the information element INF, is then stored in the corresponding storage block (step S15). If, at the end of the compression S12 of the group GRᵢ, the corresponding compressed block BCᵢ occupies the whole storage size of the storage block in which it is to be stored, no information elements INF relating to any subsequent compressed block are inserted into this block.

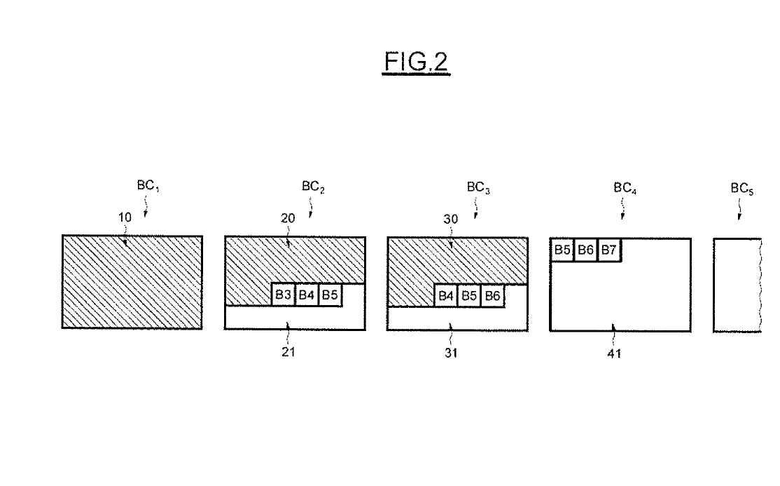

An example of an embodiment of this type is illustrated more particularly in FIG. 2. The storage size of the storage blocks intended to store the different compressed blocks is constant and depends, for example, on the compression factor of a lossy compression (e.g., a factor of 2×). In this example, it is assumed that pixels of the data group GR₁ are complex pixels, and that the lossy compression used in this case makes use of the whole of space of the block. In other words, the size of the compressed block BC₁ is equal to the storage size of the storage block in which it is to be stored.

In this case, no information element INF relating to the content of a subsequent compressed block is inserted. For the next compressed block BC₂, it is assumed that the corresponding groups of pixels are relatively simple pixels which have allowed a particularly efficient lossless compression to be carried out, resulting in a compressed content 20 whose size is smaller than the storage size of the storage blocks.

Here, there is an available space 21. This available space is then used for the insertion of a plurality of information elements INF, referenced here as B3, B4, B5, relating, respectively, to the contents of the following three compressed blocks BC₃, BC₄ and BC₅.

Similarly, after compression, the compressed block BC₃ has compressed contents 30 and an available space 31, into which the information elements B4, B5, B6 relating to the contents of the subsequent compressed blocks BC₄, BC₅ and BC₆ are inserted (these last-mentioned block being omitted from the figure for the sake of simplicity).

The same procedure is followed for the compressed block BC₄. In this example, however, the block BC₄ is completely transparent and therefore has no compressed data, but simply a free space 41 including information elements B5, B6, B7 relating, respectively, to the content of the compressed blocks BC₅, BC₆ and BC₇ (these last two blocks being omitted from the figure for the sake of simplicity).

The information element INF, for example the information elements B3, B4, B5, etc., may be an information element indicating the compression rate of the subsequent compressed block. More particularly, for the sake of simplicity, this may be the number of groups of bytes to be read in this subsequent compressed block, depending on the granularity of the memory. If, for example, the information element used is a number of groups of bytes to be read, this number of groups of bytes may relate not only to the compressed contents of the subsequent compressed block, but also to the information elements INF relating to one or more other subsequent blocks. The information element may also include a single bit indicating, for example, that all the pixels of the subsequent compressed block are transparent pixels.

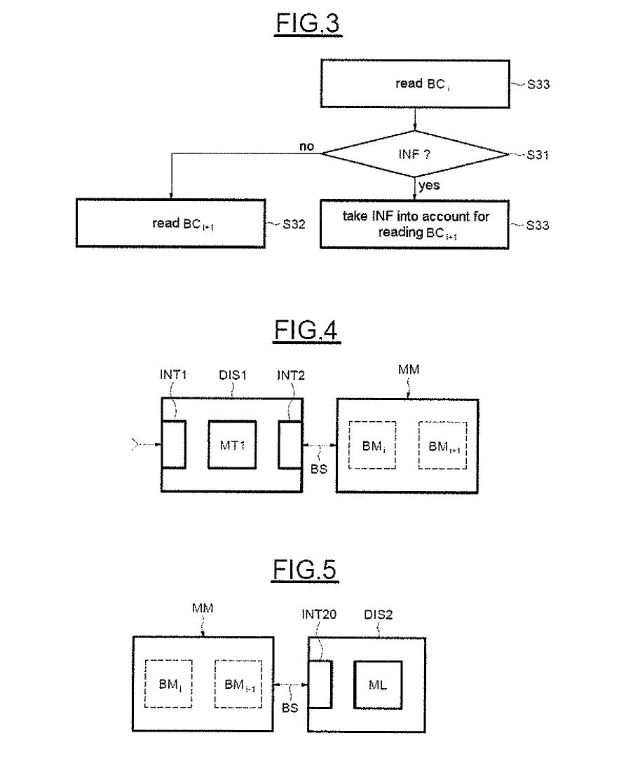

FIG. 3 shows an embodiment of a reading method based on the possible presence of these information elements INF. Thus, when a current compressed block BC₁ is read (step S30), a test is made for the presence or absence of an information element INF relating to the content of a subsequent compressed block to be read (step S31).

If this information element INF is present, this information element will be taken into account for the reading of the subsequent compressed block BCᵢ₊₁. If this is not the case, the entirety of the subsequent compressed block BCᵢ₊₁ will be read in the standard way.

Thus, returning to the example of FIG. 2, there is no preliminary information element INF for the compressed block BC₁. In this case, the entirety of the block BC₁ is read, and no information element INF relating to any subsequent compressed block is found. In this case, the entirety of the block BC₂ (including all the free space 21) is read, and, during this reading, information elements B3, B4 and B5 are found to be present in this content.

Consequently, with respect to the block BC₃, for example, the reader has access to the information element B3 during the reading of the compressed block BC₂, and it will take this information element B3 into account before reading the block BC₃. In this case, the reader does not read the entire contents of the block BC₃, but solely the compressed content 30 and the information elements B4, B5, B6.

With respect to the block BC₄, which is considered to be a transparent block, for example, the reader has gained a knowledge of the information element B4 by reading the compressed blocks BC₂ and BC₃. Since this information element B4 indicates to the reader that the block is totally transparent, the reader may then decide not to read any of this block BC₄. Thus, savings are made in bandwidth.

It should also be noted that, in this example, even if the reader does not read the compressed block BC₄, and therefore does not read the information element B5 relating to the block BC₅, the reader has still gained knowledge of this information element B5 during its reading of the preceding block BC₃or of the preceding block BC₂. This is because of the redundancy of the storage of the information element B5 in these preceding blocks.

In terms of hardware, the storage method as described above may be implemented by using a processing device DIS1 (as shown FIG. 4), e.g., an MPEG decoder. The processing device DIS1 has an interface INT1 for receiving the data and processing means or processor MT1. The processor MT1 is configured for grouping the data into successive data groups, compressing each data group into a compressed block having a block size smaller than or equal to the storage size, and, for at least one compressed block having a block size smaller than the storage size, inserting into the compressed block at least one information element relating to the contents of at least one subsequent compressed block. The device DIS1 also includes an interface INT2 connected to a bus BS linked to the memory MM organized in storage blocks BMᵢ.

With respect to the hardware for implementing a reading method as described above, it is possible to use a device DIS2, e.g., a device of the DMA (Direct Memory Access) type, connected by a bus BS to the memory MM, as shown schematically in FIG. 5. The device DIS2 has an input interface INT20 connected to the bus BS, and circuitry configured to read the contents of current compressed data block. If at least one information element relating to the contents of at least one subsequent compressed block is present in the current block, it takes into account the at least one information element for the subsequent reading of the at least one subsequent compressed block.

1-15. (canceled)

16. A method for storing data in storage blocks having a constant storage size, the method comprising:
grouping the data into successive data groups;
compressing each data group into a compressed block having a block size less than or equal to the storage size; and
for at least one compressed block having a block size smaller than the storage size, inserting into the at least one compressed block, before storage in a storage block, at least one information element relating to the content of at least one other compressed block.

17. The method of claim 16 further comprising inserting a plurality of information elements relating, respectively, to the contents of a plurality of subsequent blocks into the at least one compressed block.

18. The method of claim 17 further comprising inserting into each current compressed block of a sequence of a plurality of successive compressed blocks a plurality of information elements relating, respectively, to a sub-sequence of a plurality of successive subsequent compressed blocks, the first compressed block of the sub-sequence being the first compressed block following the current compressed block.

19. The method of claim 16 wherein the information element relates to a compression rate of the at least one subsequent block.

20. The method of claim 16 wherein the information element relates to a characteristic of the contents of the at least one subsequent block.

21. A method for reading data in successive storage blocks having a constant storage size, each storage block comprising a block of compressed data, the method comprising:
reading the contents of the current compressed data block; and
if at least one information element relating to the content of at least one subsequent compressed block is present in the current block, reading the at least one subsequent compressed block based upon the at least one information element.

22. The method of claim 21 wherein the information element relates to a compression rate of the at least one subsequent block.

23. The method of claim 21 wherein the information element relates to a characteristic of the contents of the at least one subsequent block.

24. The method of claim 21 wherein the data comprises pixel data.

25. A processing device comprising:
an input interface configured to receive data to be stored in storage blocks of a memory, the storage blocks having a constant storage size;
a processor configured to
group the data into successive data groups,
compress each data group into a compressed block having a block size smaller than or equal to the storage size, and
for at least one compressed block having a block size smaller than the storage size, insert into the at least one compressed block at least one information element relating to the contents of at least one subsequent compressed block; and
an output interface configured to deliver the successive compressed blocks to a memory containing the storage blocks.

26. The processing device of claim 25 wherein said processor is further configured to insert into the at least one compressed block a plurality of information elements relating, respectively, to the contents of a plurality of subsequent compressed blocks.

27. The processing device of claim 26 wherein said processor is further configured to insert into each current compressed block of a sequence of a plurality of successive compressed blocks a plurality of information elements, relating, respectively, to a sub-sequence of a plurality of successive subsequent compressed blocks, the first compressed block of the sub-sequence being the first compressed block following the current compressed block.

28. The processing device of claim 25 wherein the information element relates to the compression rate of the at least one subsequent block.

29. The processing device of claim 25 wherein the information element relates to a characteristic of the contents of the at least one subsequent block.

30. The processing device of claim 25 wherein the data comprises video data.

31. A processing device comprising:
an input interface coupled to a memory including successive storage blocks having a constant storage size, each storage block comprising a block of compressed data; and
reading circuitry configured to read the contents of the current compressed data block and, if at least one information element relating to the contents of at least one subsequent compressed block is present in the current block, reading the at least one subsequent compressed block based upon the at least one information element.

32. The processing device of claim 31 wherein the information element relates to a compression rate of the at least one subsequent block.

33. The processing device of claim 31 wherein the information element relates to a characteristic of the contents of the at least one subsequent block.

34. The processing device of claim 31 wherein the data comprises pixel data.
